(19) United States
(12) Patent Application Publication
(10) Pub. No.: US 2024/0302521 A1
(43) Pub. Date: Sep. 12, 2024

(54) RADAR TARGET TRACKING DEVICE AND METHOD

(71) Applicant: HL KLEMOVE CORP., Incheon (KR)

(72) Inventor: Eunjong PYO, Incheon (KR)

(21) Appl. No.: 18/597,936

(22) Filed: Mar. 7, 2024

(30) Foreign Application Priority Data
Mar. 8, 2023 (KR) 10-2023-0030559

(51) Int. Cl. G01S 13/72; G01S 13/931

(52) U.S. Cl. CPC G01S 13/72; G01S 13/931

(57) ABSTRACT

The present embodiments relates to a radar target tracking device and method. Specifically, a radar target tracking device according to the present embodiments comprises a receiver receiving detection information obtained by detecting an object around a host vehicle every preset period, a sigma point extractor calculating a measurement value for the object based on the detection information and extracting a sigma point for sampling a Gaussian distribution from a probability distribution including a position of the host vehicle and the measurement value, and a process model unit selecting a first process model that is any one of a process model set, applying the first process model to non-linearly convert the sigma point to a random vector, and outputting a mean and covariance of the random vector.

### CROSS-REFERENCE TO RELATED APPLICATION

This application claims priority from Korean Patent Application No. 10-2023-0030559, filed on Mar. 8, 2023, which is hereby incorporated by reference for all purposes as if fully set forth herein.

### BACKGROUND

### Field

The present embodiments relate to a radar target tracking device and method.

### Description of Related Art

Recently, vehicles equipped with radar are increasing. The electronic control unit of the vehicle may calculate the distance, relative velocity and angle between the vehicle and an object around the vehicle based on the information output from the radar installed in the vehicle.

As such, a radar-equipped vehicle may provide various safety and convenience functions using, e.g., the distance, relative velocity, and angle between the vehicle and the object around the vehicle.

For example, collision avoidance, smart cruse, or auto-parking may be performed by grasping the distance, angle, or relative velocity between the vehicle and the object around the vehicle using the information input from the radar equipped in the vehicle.

Meanwhile, an algorithm called Kalman Filter is being used in relation to prediction and tracking of a moving object. The Kalman filter is an algorithm that recursively predicts the state of the system, including white noise, in a linear dynamic system. However, when the movement of the object rapidly changes irregularly, an error, i.e., the difference between the predicted value and the actual value, increases, and thus the tracking of the moving object is not properly performed. Accordingly, there is a need for a technique capable of reducing such an error when predicting the movement of a moving object.

### BRIEF SUMMARY

In the foregoing background, the disclosure provides a radar target tracking device and method capable of more precise target tracking by selecting one of a plurality of process models and performing Kalman filter processing.

To achieve the foregoing objects, in an aspect, the disclosure provides a radar target tracking device comprising a receiver receiving detection information obtained by detecting an object around a host vehicle every preset period, a sigma point extractor calculating a measurement value for the object based on the detection information and extracting a sigma point for sampling a Gaussian distribution from a probability distribution including a position of the host vehicle and the measurement value, and a process model unit selecting a first process model that is any one of a process model set, applying the first process model to non-linearly convert the sigma point to a random vector, and outputting a mean and covariance of the random vector.

In another aspect, the disclosure provides a radar target tracking method comprising a detection information reception step receiving detection information obtained by detecting an object around a host vehicle every preset period, a sigma point extraction step calculating a measurement value for the object based on the detection information and extracting a sigma point for sampling a Gaussian distribution from a probability distribution including a position of the host vehicle and the measurement value, and a process model selection step selecting a first process model that is any one of a process model set, applying the first process model to non-linearly convert the sigma point to a random vector, and outputting a mean and covariance of the random vector.

According to the disclosure, the radar target tracking device and method may minimize an error due to application of a non-linear function determined by selecting one from a process model set through a deep neural network model.

Further, the disclosure may predict not only the radar target of the next period but also the radar target thereafter.

### DESCRIPTION OF DRAWINGS

The above and other objects, features, and advantages of the present disclosure will be more clearly understood from the following detailed description, taken in conjunction with the accompanying drawings, in which:

FIG. 1 is a block diagram schematically illustrating a radar target tracking device according to an embodiment of the disclosure;

FIG. 2 is a view illustrating a discrete time non-linear dynamic probability system according to an embodiment;

FIGS. 3 and 4 are views illustrating an unscented Kalman filter according to an embodiment;

FIG. 5 is a view illustrating a structure of an unscented Kalman filter according to an embodiment;

FIGS. 6 and 7 are views illustrating an input and output of a deep neural network model according to an embodiment;

FIG. 8 is a view illustrating an input of a sequence vector to a deep neural network model according to an embodiment;

FIG. 9 is a view illustrating an output of data corresponding to an input output period by a deep neural network model according to an embodiment;

FIG. 10 is a view illustrating selecting a plurality of process models and outputting a conversion result in a deep neural network according to an embodiment; and

FIG. 11 is a flowchart illustrating a radar target tracking method according to an embodiment of the disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

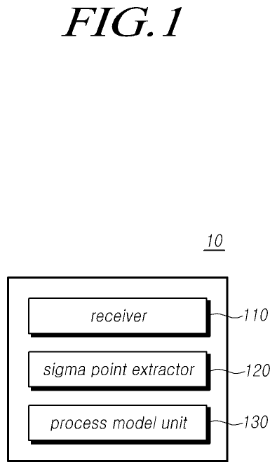

FIG. 1 is a block diagram schematically illustrating a radar target tracking device according to an embodiment of the disclosure.

The radar target tracking device 10 according to the disclosure may include a receiver 110, a sigma point extractor 120, and a process model unit 130.

In an embodiment of the disclosure, the radar target tracking device 10 may be an advance driver assistance system (ADAS) that provides information for assisting driving of a host vehicle or provides assistance for controlling the host vehicle.

Here, ADAS may refer to various types of advanced driver assistance systems and may include, e.g., autonomous emergency braking (AEB) system, smart parking assistance system (SPAS), blind spot detection (BSD), adaptive cruise control (ACC), lane departure warning system (LDWS), lane keeping assist system (LKAS), and lane change assist system (LCAS). However, embodiments of the disclosure are not limited thereto.

The radar target tracking device 10 according to the disclosure may be equipped in a manned vehicle which is controlled by the driver aboard or an autonomous vehicle.

The radar target tracking device 10 may receive detection information obtained by detecting an object around the host vehicle at each preset period, calculate a measurement value for the object based on the detection information, extract a sigma point for sampling a Gaussian distribution from a probability distribution including the position and the measurement value of the host vehicle, select a first process model which is any one from a process model set, apply the first process model to non-linearly convert the sigma point to a random vector, and output the mean and covariance of the random vector.

Accordingly, the radar target tracking device 10 may predict the position and the path of the radar target in the next or subsequent periods through the calculated mean and covariance of the random vector, and track the radar target.

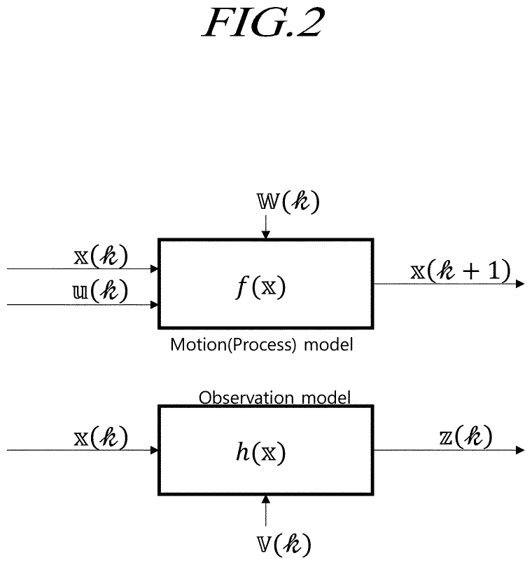

FIG. 2 is a view illustrating a discrete time non-linear dynamic probability system according to an embodiment.

In general, a filter used to track the radar target is an unscented Kalman filter (UKF), which may estimate the discrete time non-linear dynamic probability system.

Such a discrete-time non-linear dynamic probability system may be described as Equation 1 below.

$$𝕩 ( 𝓀 + 1 ) = f ( 𝕩 ( 𝓀 ) , 𝕦 ( 𝓀 ) , 𝓀 ) + {G}_{w} ( 𝓀 ) 𝕨 ( 𝓀 ) \\ 𝕫 ( 𝓀 ) = h ( 𝕩 ( 𝓀 ) , 𝓀 ) + 𝕧 ( 𝓀 ) \\ 𝕩 ( 0 ) \sim ( {\overline{𝕩}}_{0} , {P}_{0} ) \\ 𝕨 ( 𝓀 ) \sim ( 0 , Q ( 𝓀 ) ) , 𝕧 ( 𝓀 ) \sim ( 0 , R ( 𝓀 ) ) \qquad [ Equation 1 ]$$

According to Equation 1, the motion model may estimate the observation model at the time point k+1 by receiving and processing detection information of the radar sensor generated by the observation model at the time point k and external noise as input signals.

This discrete-time non-linear dynamic probability system may be assumed as Equation 2 below.

$$E [ 𝕨 ( 𝓀 ) {𝕨}^{T} ( ℓ ) ] = Q ( 𝓀 ) {δ}_{𝓀ℓ} , \\ E [ 𝕧 ( 𝓀 ) {𝕧}^{T} ( ℓ ) ] = R ( ?? ) {δ}_{𝓀ℓ} , \\ E [ 𝕨 ( 𝓀 ) {𝕧}^{T} ( ℓ ) ] = 0 , \\ E [ ( 𝕩 ( 0 ) - {\overline{𝕩}}_{0} ) {𝕨}^{T} ( 𝓀 ) ] = 0 , \\ E [ ( 𝕩 ( 0 ) - {\overline{𝕩}}_{0} ) {𝕧}^{T} ( 𝓀 ) ] = 0 \qquad [ Equation 2 ]$$

According to Equation 2, in the discrete time non-linear dynamic probability system, it may be assumed that the covariance calculated in the discrete time non-linear dynamic probability system and the error covariance generated in the observation model do not affect each other, and that the error noise of the discrete time non-linear dynamic probability system and the error noise of the observation model do not affect each other.

As described above, the unscented Kalman filter may update the time information for the estimated information at the next time point k+1 predicted as described above, and calculate the estimated information at the next time point k+2 based on the updated time information.

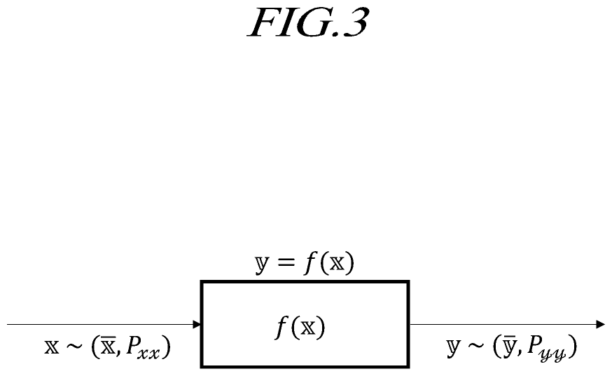

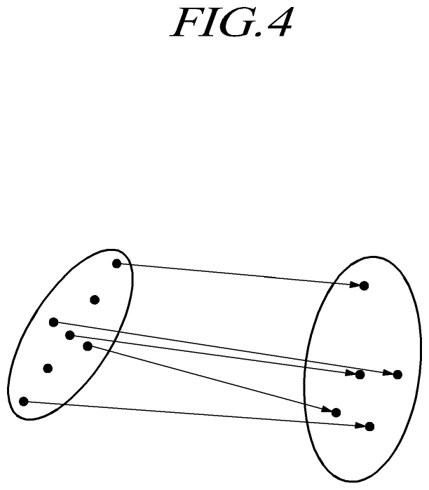

FIGS. 3 and 4 are views illustrating an unscented Kalman filter according to an embodiment.

Referring to FIGS. 3 and 4, the unscented Kalman filter may perform non-linear deformation on a predetermined input random vector using a non-linear function f(x), and may calculate the mean and covariance of new random vectors generated through the non-linear deformation.

The unscented Kalman filter may extract a sigma point from the random vector before the random vector is non-linearly deformed by the process model.

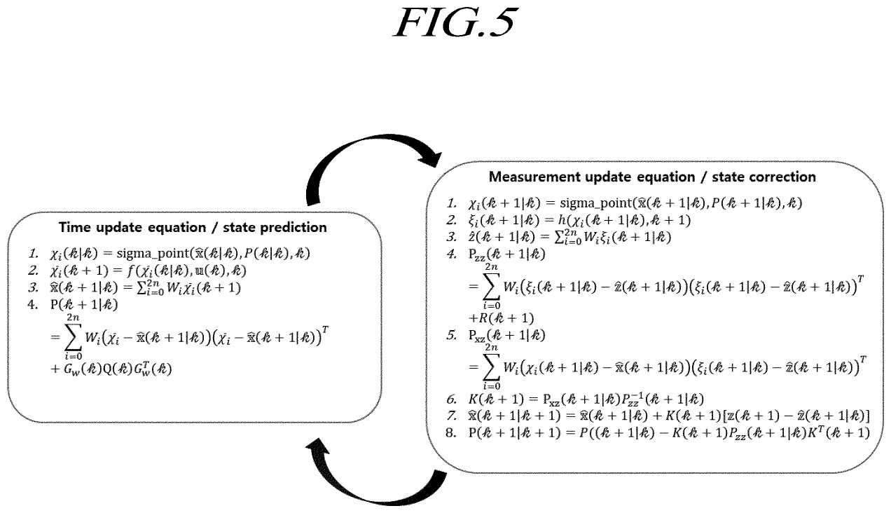

FIG. 5 is a view illustrating a structure of an unscented Kalman filter according to an embodiment.

The above-described process may be expressed as shown in FIG. 5. Referring to FIG. 5, such a cyclic structure may be formed that the detection information may be updated based on the update of the time information and the updated time information, and the time information may be updated based on the updated detection information.

This unscented Kalman filter may track the radar target with relatively high accuracy in estimating the non-linear function system.

However, when the distribution model of the system to be estimated deviates from the Gaussian probability distribution or is a function that does not follow the assumed non-linear function model, the filter performance of the unscented Kalman filter decreases.

Accordingly, the disclosure provides a method for enhancing filter performance even for a function that does not follow the above-described non-linear function model by selecting a non-linear function model as any one of a plurality of functions.

The receiver 110 may receive detection information obtained by detecting an object around the host vehicle every preset period.

In an example, the receiver 110 may receive detection information from a radar sensor mounted to the vehicle.

Here, the radar sensor may include an antenna unit, a radar transmitter, a radar receiver, and the like.

Specifically, the antenna unit may include one or more transmission antennas and one or more reception antennas. Each transmission/reception antenna may be an array antenna including one or more radiation elements connected in series through feeding lines but is not limited thereto.

The antenna unit may include a plurality of transmission antennas and a plurality of reception antennas and may have various array structures depending on the arrayed order and arrayed interval.

The radar transmitter may switch to one of the plurality of transmission antennas included in the antenna unit to transmit transmission signals through the switched transmission antenna or may transmit transmission signals through multiple transmission channels allocated to the plurality of transmission antennas.

The radar transmitter include an oscillation unit that generates transmission signals for one transmission channel allocated to the switched transmission antenna or multiple transmission channels allocated to the plurality of transmission antennas. The oscillator may include, e.g., a voltage-controlled oscillator (VCO) and an oscillator.

The radar receiver may receive a reception signal, which is reflected by the object, through the reception antenna.

The radar receiver may switch to one of the plurality of reception antennas and receive the reception signal, which is the transmission signal reflected by the target, through the switched reception antenna or receive the reception signal through multiple reception channels allocated to the plurality of reception antennas.

The radar receiver may include, e.g., a low noise amplifier (LNA) that low-noise amplifies the reception signal, which is received through one reception channel allocated to the switched reception antenna or through multiple reception channels allocated to the plurality of reception antennas, a mixer that mixes the low-noise amplified reception signal, an amplifier that amplifies the mixed reception signal, and an analog-digital converter (ADC) that converts the amplified reception signal into a digital signal to thereby generate reception data.

In another example, the receiver 110 may control the above-described radar sensor to output a control signal to be transmitted to the radar, and receive a reception signal from the radar sensor. The detection information of the disclosure may be a reception signal received from a radar sensor or reception data obtained by digitally converting the reception signal.

The period in the disclosure may refer to a time from transmission of a transmission signal by the radar transmitter through reception and processing of the reception signal by the radar receiver to transmission of another transmission signal by the radar transmitter. Also, in the disclosure, the first period may be referred to as a 1st scan, and the second period may be referred to as a 2nd scan.

The sigma point extractor 120 may calculate a measurement value for the object based on the detection information, and extract a sigma point for sampling a Gaussian distribution from a probability distribution including the position of the host vehicle and the measurement value.

Here, the sigma point may be extracted from the measurement value calculated from the detection information received in the current period. Then, a weight for the sigma point may be calculated.

The process model unit 130 may select a first process model that is any one from a process model set, apply the first process model to non-linearly convert the sigma point to a random vector, and output the mean and covariance of the random vector.

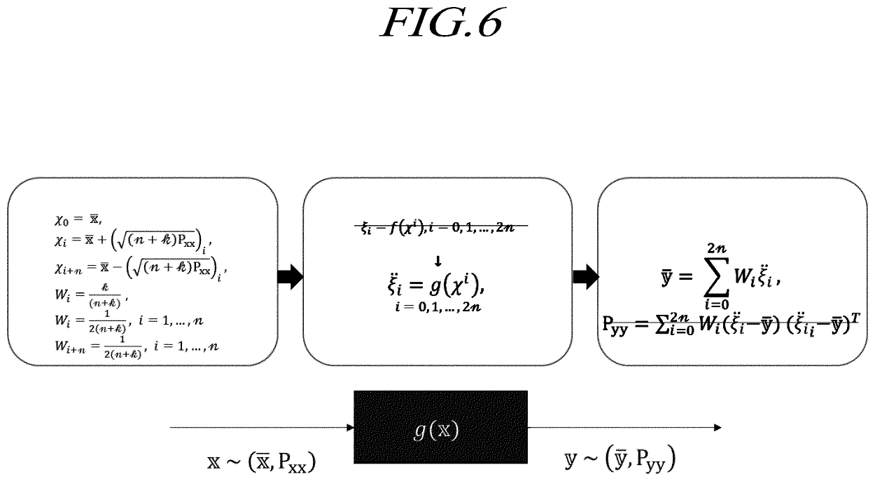

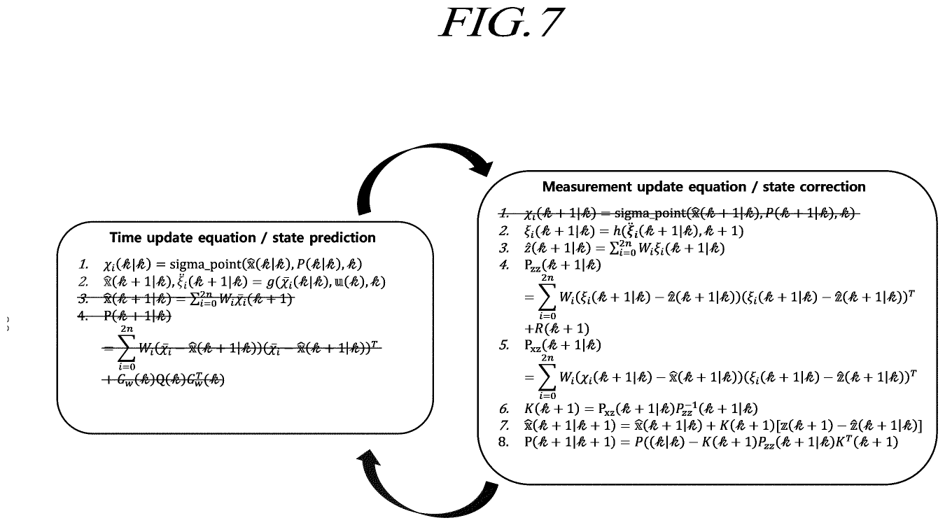

FIGS. 6 and 7 are views illustrating an input and output of a deep neural network model according to an embodiment.

Referring to FIG. 6, the process model unit 130 may input the sigma point to the deep neural network model, and select the first process model from the process model set based on the result value of the deep neural network model. Here, the process model set may include at least one of, e.g., a constant velocity motion model, a constant acceleration motion model, and a constant velocity orbiting motion model.

The process model unit 130 may input the result of calculation of the sigma point and the weight of sigma point by the sigma point extractor 120 to the deep neural network g(x). The deep neural network model g(x) may include, e.g., a trained process model non-linear function.

The deep neural network model may select a first process model from a process model set through a data-driven method.

The process model unit 130 may perform non-linear progress by applying the first process model to the sigma point and the weight. Accordingly, the process model unit 130 may generate a random vector and output the mean and covariance of a new distribution for the random vector.

The input and output of the input model of the deep neural network described above may be expressed by an equation, as shown in FIG. 7.

Referring to FIG. 7, the equation of FIG. 7 may be expressed by removing duplicate equations in the state prediction and state correction parts, and replacing the equation for calculating the sigma point in the state correction to be calculated as the output of the deep neural network model g(x). In other words, the deep neural network model may further output a sigma point of the generated random vector.

Further, time information and measurement information may be updated based on each other, such as a general unscented Kalman filter.

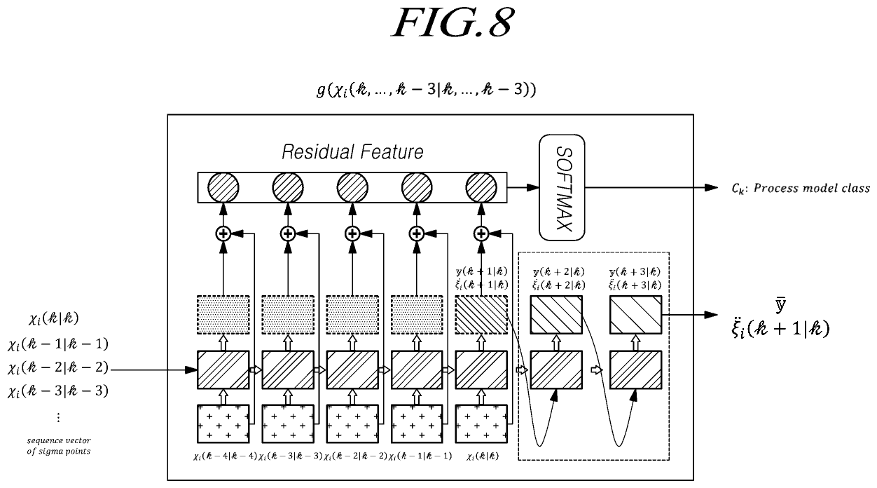

FIG. 8 is a view illustrating an input of a sequence vector to a deep neural network model according to an embodiment.

Referring to FIG. 8, the process model unit 130 may receive a sequence vector of a sigma point and select a first process model. Specifically, the sequence vector of the sigma point may include the sigma point extracted every period from a predetermined period to the current period. Referring to FIG. 8, e.g., the predetermined period is k−3, and the current period is k. The sigma point may be extracted every period from the k−3 period to the k period, and a sequential set of the sigma points may be set as a sequence vector of the sigma points.

The deep neural network model may be trained based on the data processed by sequentially inputting the sequence vector of the sigma point to the deep neural network model. The process model unit 130 may confirm the first process model from the process model set based on the training result of the deep neural network model. The uncertainty covariance of the process model may also be updated through the deep neural network model. In other words, the process model may be classified using the residual feature of FIG. 8.

In an embodiment, the deep neural network model may select a first process model from a process model set through a data-driven method.

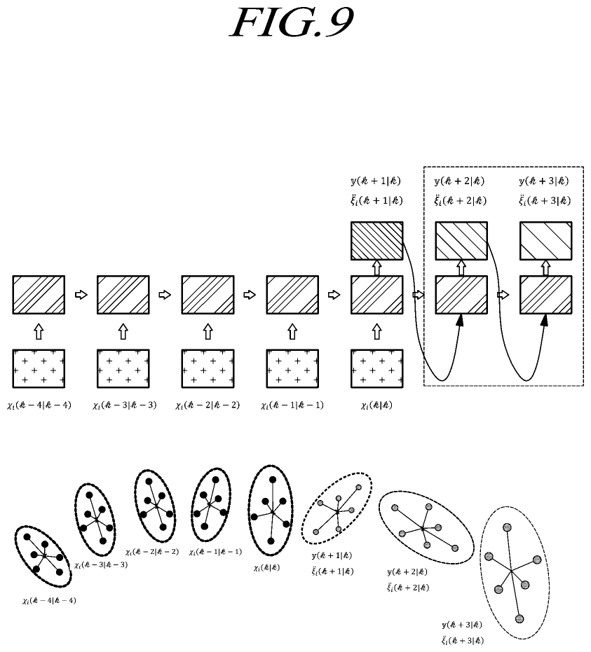

FIG. 9 is a view illustrating an output of data corresponding to an input output period by a deep neural network model according to an embodiment.

Referring to FIG. 9, the process model unit 130 may further receive an output period and output the mean and covariance of random vectors corresponding to the output period. Here, the output period may be a period to be estimated through the deep neural network model. For example, when the input output period is k+3, the deep neural network model may output the mean and covariance of the random vector corresponding to k+3.

The process model unit 130 may perform estimation of random vector and extraction of sigma point of the k+2 period using the output value of the k+1 period as an input value and perform estimation of random vector and extraction of sigma point of the k+3 period using the output value of the k+2 period as an input value.

The radar target tracking device according to the disclosure may output the mean and covariance of random vectors at the time corresponding to the input output period as well as the next period by receiving the sequence vector and calculating a tendency, unlike estimation of a general unscented Kalman filter. In other words, according to the disclosure, the time step to be predicted by the deep neural network model may be adjusted.

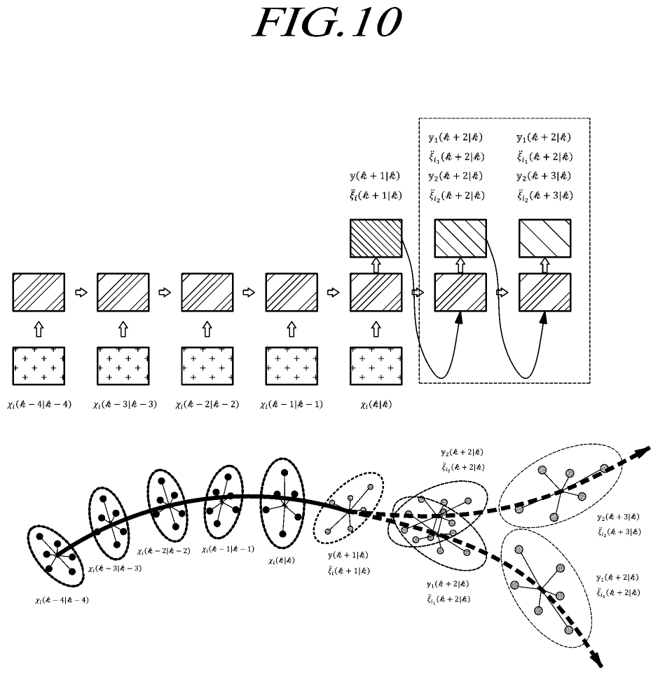

FIG. 10 is a view illustrating selecting a plurality of process models and outputting a conversion result in a deep neural network according to an embodiment.

Referring to FIG. 10, when the uncertainty regarding the processing result of the first process model is greater than or equal to a predetermined threshold, the process model unit 130 may further select a second process model from the process model set and output the processing result of the second process model and the conversion result of the first process model.

Specifically, the process model unit 130 may further determine the uncertainty regarding the processing result of the first process model which is the selected process model, and when the uncertainty regarding the processing result is greater than or equal to a predetermined threshold, the process model unit 130 may further select the second process model which is another process model. Further, the process model unit 130 may output both the processing result of the first process model and the processing result of the second process model. Accordingly, two prediction paths of the radar target may be calculated.

The uncertainty about the processing result of the above-described process model may be determined within the deep neural network model.

As described above, the radar target tracking device according to the disclosure may more accurately track the radar target by selecting a different process model according to the situation and calculating a prediction result. Further, the disclosure may adaptively detect multiple model targets by using a sequence vector of sigma points as input data.

According to an embodiment, the radar target tracking device may be implemented as an electronic control unit (ECU). The ECU may include at least one or more of one or more processors, a memory, a storage unit, a user interface input unit, or a user interface output unit which may communicate with one another via a bus. The computer system may also include a network interface for accessing a network. The processor may be a central processing unit or semiconductor device that executes processing instructions stored in the memory and/or the storage unit. The memory and the storage unit may include various types of volatile/non-volatile storage media. For example, the memory may include a read only memory (ROM) and a random access memory (RAM).

Described below is a radar target tracking method using the radar target tracking device capable of performing the above-described embodiments of the disclosure.

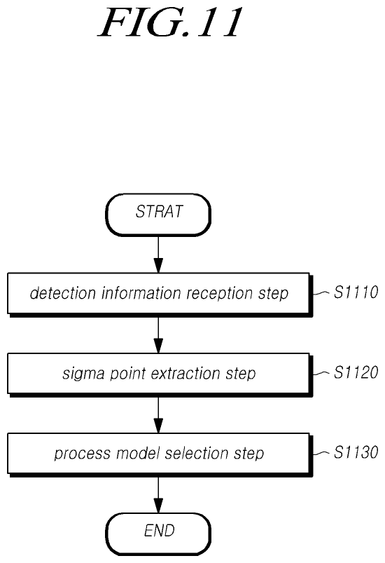

FIG. 11 is a flowchart illustrating a radar target tracking method according to an embodiment of the disclosure.

Referring to FIG. 11, a radar target tracking method according to the disclosure may include a detection information reception step S1110 receiving detection information obtained by detecting an object around a host vehicle at each preset period, a signal point extraction step S1120 calculating a measurement value for the object based on the detection information and extracting a sigma point for sampling a Gaussian distribution from a probability distribution including the position and the measurement value of the host vehicle, and a process model selection step S1130 selecting a first process model which is any one from a process model set, applying the first process model to non-linearly convert the sigma point to a random vector, and outputting the mean and covariance of the random vectors.

Here, the process model set may include at least one of a constant velocity motion model, a constant acceleration motion model, and a constant velocity orbiting motion model.

The sigma point extraction step S1120 may further extract a weight for the sigma point.

The process model selection step S1130 may receive the sigma point and select one from the process model set may be selected through the deep neural network model. Accordingly, the disclosure may minimize an error according to the application of the determined non-linear function.

In an embodiment, the deep neural network model may select one from a process model set through a data-driven method.

The process model selection step S1130 may receive the sequence vector of the sigma point to select the first process model. The sequence vector may include the sigma point extracted every period from a predetermined period to the current period.

When the uncertainty regarding the processing result of the first process model is greater than or equal to a predetermined threshold, the process model selection step S1130 may further select a second process model from the process model set and output the processing result of the second process model and the conversion result of the first process model. The radar target tracking device may determine uncertainty about the processing result of the selected process model, and may further output the processing result of another process model as an alternative.

The process model selection step S1130 may further output a sigma point of the random vector.

The process model selection step S1130 may further receive an output period and output the mean and covariance of random vectors corresponding to the output period. In other words, the time step to be predicted by the deep neural network model may be adjusted.

As described above, according to the disclosure, the radar target tracking device and method may minimize an error due to application of a non-linear function determined by selecting one from a process model set through a deep neural network model.

Further, the disclosure may predict not only the radar target of the next period but also the radar target thereafter.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed:

1. A radar target tracking device, comprising:
a receiver receiving detection information obtained by detecting an object around a host vehicle every preset period;
a sigma point extractor calculating a measurement value for the object based on the detection information and extracting a sigma point for sampling a Gaussian distribution from a probability distribution including a position of the host vehicle and the measurement value; and
a process model unit selecting a first process model that is any one of a process model set, applying the first process model to non-linearly convert the sigma point to a random vector, and outputting a mean and covariance of the random vector.

2. The radar target tracking device of claim 1, wherein the process model unit inputs the sigma point to a deep neural network model and selects the first process model from the process model set based on a result value of the deep neural network model.

3. The radar target tracking device of claim 2, wherein the deep neural network model selects the first process model from the process model set through a data-driven method.

4. The radar target tracking device of claim 2, wherein the process model unit receives the sequence vector of the sigma point and selects the first process model.

5. The radar target tracking device of claim 4, wherein the sequence vector includes the sigma point extracted every period from a predetermined period to a current period.

6. The radar target tracking device of claim 4, wherein if an uncertainty for a processing result of the first process model is greater than or equal to a predetermined threshold, the process model unit further selects a second process model from the process model set and outputs a processing result of the second process model and a conversion result of the first process model.

7. The radar target tracking device of claim 1, wherein the process model unit further outputs the sigma point of the random vector.

8. The radar target tracking device of claim 1, wherein the process model set includes at least one of a constant velocity motion model, a constant acceleration motion model, and a constant velocity orbiting motion model.

9. The radar target tracking device of claim 1, wherein the sigma point extractor further extracts a weight for the sigma point.

10. The radar target tracking device of claim 1, wherein the process model unit further receives an output period and outputs a mean and covariance of a random vector corresponding to the output period.

11. A radar target tracking method, comprising:
a detection information reception step receiving detection information obtained by detecting an object around a host vehicle every preset period;
a sigma point extraction step calculating a measurement value for the object based on the detection information and extracting a sigma point for sampling a Gaussian distribution from a probability distribution including a position of the host vehicle and the measurement value; and
a process model selection step selecting a first process model that is any one of a process model set, applying the first process model to non-linearly convert the sigma point to a random vector, and outputting a mean and covariance of the random vector.

12. The radar target tracking method of claim 11, wherein the process model selection step receives the sigma point and selects one from the process model set through a deep neural network model.

13. The radar target tracking method of claim 12, wherein the deep neural network model selects one from the process model set through a data-driven method.

14. The radar target tracking method of claim 12, wherein the process model selection step receives the sequence vector of the sigma point and selects the first process model.

15. The radar target tracking method of claim 14, wherein the sequence vector includes the sigma point extracted every period from a predetermined period to a current period.

16. The radar target tracking method of claim 14, wherein if an uncertainty for a processing result of the first process model is greater than or equal to a predetermined threshold, the process model selection step further selects a second process model from the process model set and outputs a processing result of the second process model and a conversion result of the first process model.

17. The radar target tracking method of claim 11, wherein the process model selection step further outputs the sigma point of the random vector.

18. The radar target tracking method of claim 11, wherein the process model set includes at least one of a constant velocity motion model, a constant acceleration motion model, and a constant velocity orbiting motion model.

19. The radar target tracking method of claim 11, wherein the sigma point extraction step further extracts a weight for the sigma point.

20. The radar target tracking method of claim 11, wherein the process model selection step further receives an output period and outputs a mean and covariance of a random vector corresponding to the output period.
